(19) United States
(12) Patent Application Publication
(10) Pub. No.: US 2014/0310552 A1
(43) Pub. Date: Oct. 16, 2014

(54) REDUCED-POWER SLEEP STATE S3

(71) Applicant: ADVANCED MICRO DEVICES, INC., Sunnyvale, CA (US)

(72) Inventors: Ming L. SO, Danville, CA (US); Xiao Gang Zheng, Sunnyvale, CA (US)

(73) Assignee: Advanced Micro Devices, Inc., Sunnyvale, CA (US)

(21) Appl. No.: 13/862,854

(22) Filed: Apr. 15, 2013

(51) Int. Cl. G06F 1/32; G06F 3/06

(52) U.S. Cl. CPC G06F 1/3275; G06F 3/0604; G06F 3/065; G06F 3/0683
USPC 713/324; 711/162; 711/105

(57) ABSTRACT

Current computer systems support sleep states such as sleep state S3 and sleep state S4. A system in sleep state S3 utilizes more power than one in sleep state S4, however, a system in sleep state S3 can resume function substantially faster than a system in sleep state S4. An idle system is often put into sleep state S3 rather than sleep state S4 because of the shorter resume time even though sleep state S3 utilizes more power. Embodiments include a reduced-power sleep state S3 that uses less power than sleep state S3 yet resumes function faster than sleep state S4. Embodiments reduce the power consumed by compressing and consolidating system context to fewer memory modules, and powering down unused memory modules. Embodiments thus avoid storing system content to non-volatile memory. Embodiments include waking the system by restoring system context in the reverse order to respective memory modules.

### BACKGROUND

1. Field

The embodiments are generally directed to managing states of a processor, and more specifically to sleep states.

2. Background Art

Current computer systems support several sleep states such as sleep state S3 (suspend) and sleep state S4 (hibernation). Each of the sleep states is associated with a level of power consumption and a length of time or latency to resume from a sleep state to its prior state.

Computer systems in sleep state S3 consume more power than those in sleep state S4, but the resume latency in sleep state S4 is much longer than the latency in sleep state S3.

### BRIEF SUMMARY OF EMBODIMENTS

Therefore, what is needed is a method, computer program product, and system that substantially reduces power consumption compared to sleep state S3 while having a resume time that is substantially shorter than sleep state S4.

Embodiments for entering a reduced-power sleep state S3 include a method, computer program product, and system. For example, the system includes a memory device that is scanned to determine based on data in the memory device, the minimum number of consolidated memory modules needed to store the data in the memory device as compressed data. Memory modules in the device are identified as temporary memory modules and the remaining ones as consolidated memory modules. Data is compressed and stored in the memory device. The compressed data in the memory device is first copied to the respective temporary memory modules. The respective consolidated memory modules contain no compressed data and are available for storage. The compressed data is copied a second time from the respective temporary memory modules to the respective consolidated memory modules. A memory module is a volatile memory device, thus, the contents will be lost when the memory module is powered down. Contents can be preserved, however, in a low power state called self-refresh mode. The respective consolidated memory modules are placed into self-refresh mode. Embodiments further include powering down the respective temporary memory modules.

Memory modules typically have memory allocation for use by a graphics engine called frame buffer memory. A large portion of frame buffer memory is typically unused. The unused portion can be used as scratch pad memory that is available for local storage similar to L1 cache. In some embodiments the compressed data in the memory device is copied to a scratch pad memory within a frame buffer memory within the respective temporary memory modules.

Embodiments for exiting a reduced-power sleep state S3 include a method, computer program product, and system including copying a third time, the compressed data from the respective consolidated memory modules back to the respective temporary memory modules from which the compressed data originated, copying a fourth time, the compressed data from the respective temporary memory modules back to the memory modules from which the compressed data originated, and decompressing the compressed data in the memory modules.

Embodiments include system context data stored in the memory modules, which includes at least one of system configuration information, application data, operating system information, user data, and displayed images.

In another embodiment, a memory module is a Dynamic Random-access Memory (DRAM) module.

Further features and advantages of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURE

The accompanying drawings, which are incorporated herein and form part of the specification, illustrate the embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

FIG. 1 is a block diagram of a computer system that supports an embodiment of reduced-power sleep state S3.

FIG. 2 is a diagram of a memory module according to an embodiment.

FIG. 3 is a flowchart depicting a method for entering reduced-power sleep state S3, according to an embodiment.

FIG. 4 is a diagram depicting a method for entering reduced-power sleep state S3, according to an embodiment.

FIG. 5 is a flowchart depicting a method for exiting reduced-power sleep state S3, according to an embodiment.

FIG. 6 is a diagram depicting a method for exiting reduced-power sleep state S3, according to an embodiment.

FIG. 7 illustrates an example computer system in which embodiments of reduced-power sleep state S3 may be implemented.

The embodiments will be described with reference to the accompanying drawings. Generally, the drawing in which an element first appears is typically indicated by the leftmost digit(s) in the corresponding reference number.

### DETAILED DESCRIPTION OF EMBODIMENTS

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments” does not require that all embodiments include the discussed feature, advantage or mode of operation. Alternate embodiments may be devised without departing from the scope of the disclosure, and well-known elements of the disclosure may not be described in detail or may be omitted so as not to obscure the relevant details. In addition, the terminology used herein is for the purpose of describing particular embodiments only and is not intended to be limiting of the disclosure. For example, as used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof

Electronic devices process data and provide many applications to users. Example electronic devices include, but are not limited to, mobile phones, personal computers, workstations, and game consoles. Electronic devices use a central processing unit (“CPU”) to process data. A CPU is a processor which carries out instructions of computer programs or applications. For example, a CPU carries out instructions by performing arithmetical, logical and input/output operations. In an embodiment, a CPU performs control instructions that include decision making code of a computer program or an application, and delegates processing to other processors in the electronic device, such as a graphics processing unit (“GPU”).

A GPU is a processor that is a specialized electronic circuit designed to rapidly process mathematically intensive applications on electronic devices. The GPU has a highly parallel structure that is efficient for parallel processing of large blocks of data, such as mathematically intensive data common to computer graphics applications, images and videos. The GPU may receive data for processing from a CPU or generate data for processing from previously processed data and operations. In an embodiment, the GPU is a hardware-based processor that uses hardware to process data in parallel.

Due to advances in technology, a GPU also performs general purpose computing (also referred to as GPGPU computing). In the GPGPU computing, a GPU performs computations that traditionally were handled by a CPU. A GPU and GPGPU are examples of a graphics engine. An accelerated processing unit (APU) includes the functions of a CPU and a GPU or GPGPU.

In an embodiment, a GPU includes one or more compute units that process data. A compute unit includes arithmetic logic units (ALU's) and other resources that process data on the GPU. Data can be processed in parallel within and across compute units.

In an embodiment, a control processor on a GPU schedules task processing on compute units. Tasks include computation instructions. Those computation instructions may access data stored in the memory system of an electronic device and manipulate the accessed data. In an embodiment, the data may be stored in volatile or non-volatile memory. An example of volatile memory includes random access memory (RAM). Examples of RAM include dynamic random access memory (DRAM) and static random access memory (SRAM). Volatile memory typically stores data as long as the electronic device receives power. Examples of non-volatile memory include read-only memory, flash memory, ferroelectric RAM (F-RAM), hard disks, floppy disks, magnetic tape, optical discs, etc. Non-volatile memory retains its memory state when the electronic device loses power or is turned off.

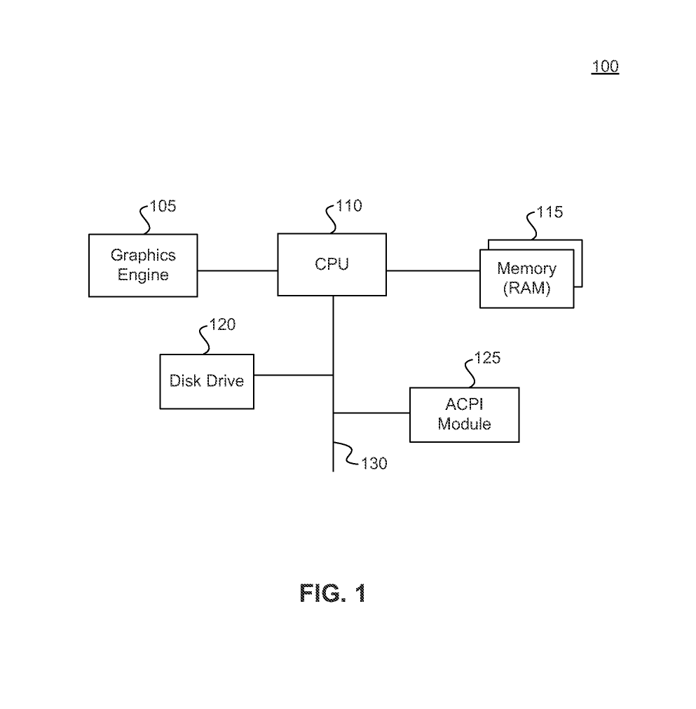

FIG. 1 is a block diagram of a computer system 100 that supports an embodiment of reduced-power sleep state S3. In the example shown, system 100 includes a graphics engine 105, CPU 110, RAM memory 115, disk drive 120 that includes hard disks, Advanced Configuration and Power Interface (ACPI) module 125, and bus 130.

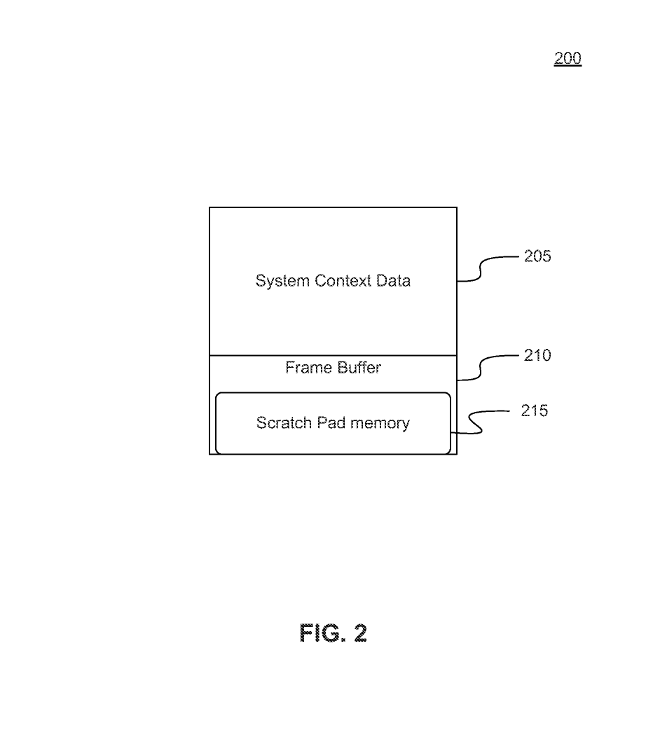

Memory 115 includes more than one memory module such as a dual in-line memory module (DIMM). A DIMM is an example of a DRAM module. FIG. 2 is a diagram of a memory module 200 according to an embodiment. Memory module 200 includes allocations for at least system context data 205 and frame buffer memory 210. System context data 205 is the state of a computer system prior to entering a sleep state. System context data 205 can include several types of data, e.g., system configuration information: peripheral devices connected, hard disk drive size, and USB connections; application data: programs that are open; operating system information: background processes; user data such as spreadsheets and photos; and images currently displayed. Frame buffer memory 210 is allocated for use by graphics engine 105. Typically, a large portion of frame buffer memory 210 is unused. Some embodiments utilize the unused portion as scratch pad memory 215 that is available to CPU 110 for storing and retrieving data, similar to L1 cache.

Bus 130 may be any type of communication infrastructure used in computer systems, including a peripheral component interface (PCI) bus, a memory bus, a PCI Express (PCIE) bus, front-side bus (FSB), hypertransport (HT), or another type of communication structure or communications channel whether presently available or developed in the future. Note that in embodiments, graphics engine 105 may also be connected to bus 130.

Advanced Configuration and Power Interface (ACPI) specification is an industry standard that supports placing unused electronic devices, including computer systems, in a low-power or sleep state, when possible, to conserve energy. Many computers are configured to enter sleep state S3 instead of sleep state S4, because sleep state S4 takes longer for a computer system to resume operation, even though sleep state S3 uses more power. Because sleep state S3 uses more power, battery operated electronic devices in sleep state 3, such as computer systems, experience battery drainage and loss of power faster than battery operated electronic devices in sleep state 4.

In one example, to enter sleep state S3 CPU 110 sends an indication to ACPI module 125 that CPU 110 is entering sleep state S3. In the example, memory 115 is placed in self-refresh mode, a low-power mode, to preserve system context data 205. ACPI module 125 then powers down the remaining components including CPU 110, graphics engine 105, and disk drive 120. In one example, the system power consumption in sleep state S3 is in the range of a few hundred milliwatts. To wake the computer system or exit from sleep state S3, ACPI module 125 restores power to the components. In one example, the resume time is in the range of 2-3 seconds.

In one example, to enter sleep state S4, CPU 110 sends an indication to ACPI module 125 that CPU 110 is entering sleep state S4. CPU 110 saves system context data 205 in memory 115 to hard disks in disk drive 120. ACPI module 125 then powers down all the components including memory 115, graphics engine 105, CPU 110, and disk drive 120.

In one example, the system power consumption in sleep state S4 is in the range of 50 milliwatts, much less than that of sleep state S3.

To wake the computer system 100 or exit from sleep state S4, ACPI module restores power to the components. The resume time for sleep state S4 can be more than ten times that of the resume time of sleep state S3, a significant delay that is noticeably slow to users.

One reason for the extended resume time for sleep state S4 as compared to sleep state sleep state S3 is that disk drive 120 is a mechanical device. Disk drive 120 has to resume power, and then information is retrieved the hard disks within disk drive 120 back to memory 115. Thus, an idle system is often put into sleep state S3 rather than sleep state S4 for a shorter resume time even though sleep state S3 depletes battery power faster.

Embodiments are provided that result in a reduced-power sleep state S3, which can conserve energy like sleep state S4, yet resume from the sleep state quickly like sleep state S3. For example, embodiments include compressing and consolidating system context data 205 into at least one of the memory modules of memory 115. Remaining unused memory modules of memory 115 are powered down. The memory module(s) containing the consolidated, compressed data is put into self-refresh mode, which reduces the power consumption compared to sleep state S3. In the example, storing data into disk drive 120 before power down is avoided. Thus, one or the main contributors to the lengthy resume time in sleep state S4, namely, powering up disk drive 120 and restoring data from disk drive 120 to memory 115, are avoided.

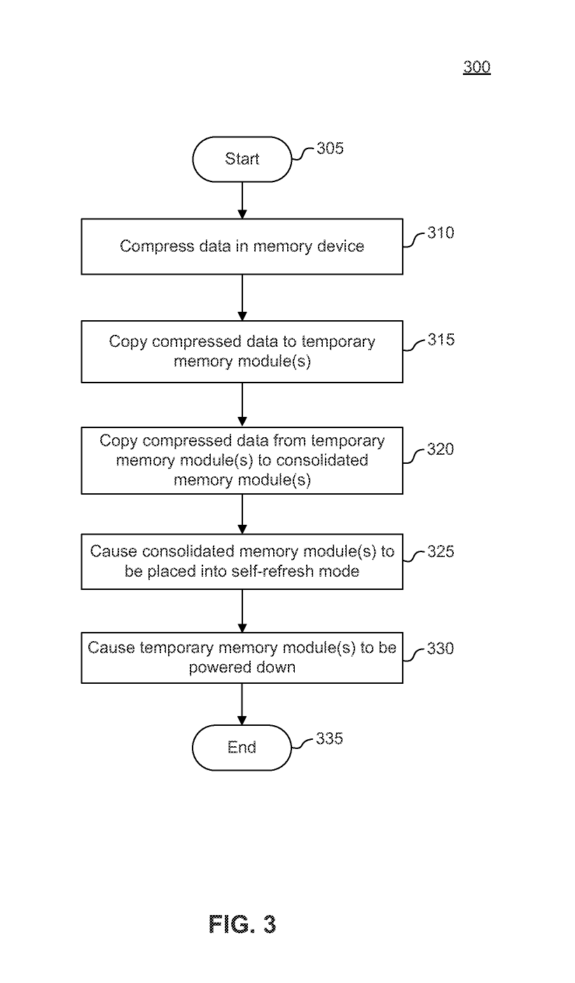

FIG. 3 is a flowchart depicting method 300 for entering reduced-power sleep state S3, according to an embodiment. In one example, system 100 and memory module 200 may be used to perform method 300. It is to be appreciated that operations in method 300 may be performed in a different order than shown, and method 300 may not include all operations shown. For ease of discussion, and without limitation, method 300 will be described in terms of elements shown in FIG. 1 and FIG. 2.

The method begins at step 305 and proceeds to step 310.

In step 310, CPU 110 sends an indication to ACPI module 126 that CPU 110 is entering reduced-power sleep state S3. In an embodiment, CPU 110 scans the memory modules of memory 115. Based on the amount of data in the memory modules, CPU 110 identifies some memory modules as temporary memory modules and the remaining ones as consolidated memory modules. CPU 110 then compresses system context data 205 in the memory modules of memory 115.

In step 315, CPU 110 copies the compressed data from the memory modules of memory 115 to the respective temporary memory modules. The respective consolidated memory modules contain no compressed data and are now available for storage.

In step 320, CPU 110 copies the compressed data from the respective temporary memory modules to the respective consolidated memory modules to consolidate all of the compressed data into the minimum memory modules necessary.

In step 325, CPU 110 causes the respective consolidated memory modules containing all of the compressed data to be placed into self-refresh mode to maintain the compressed data, i.e., CPU 110 issues a command to ACPI module 125 to initiate a sleep entry sequence. ACPI module 125 is configured to transmit an indicator to a memory controller (not shown) to cause the respective consolidated memory modules to be placed in self-refresh mode.

In step 330, CPU 110 causes the respective temporary memory modules of memory 115 to be powered down. At the end of the sleep entry sequence, ACPI module 125 powers down the entire system except the respective consolidated memory modules containing the compressed data. Thus, the respective temporary memory modules of memory 115, CPU 110, graphics engine 105, and disk drive 120 are powered down.

In step 335 method 300 ends.

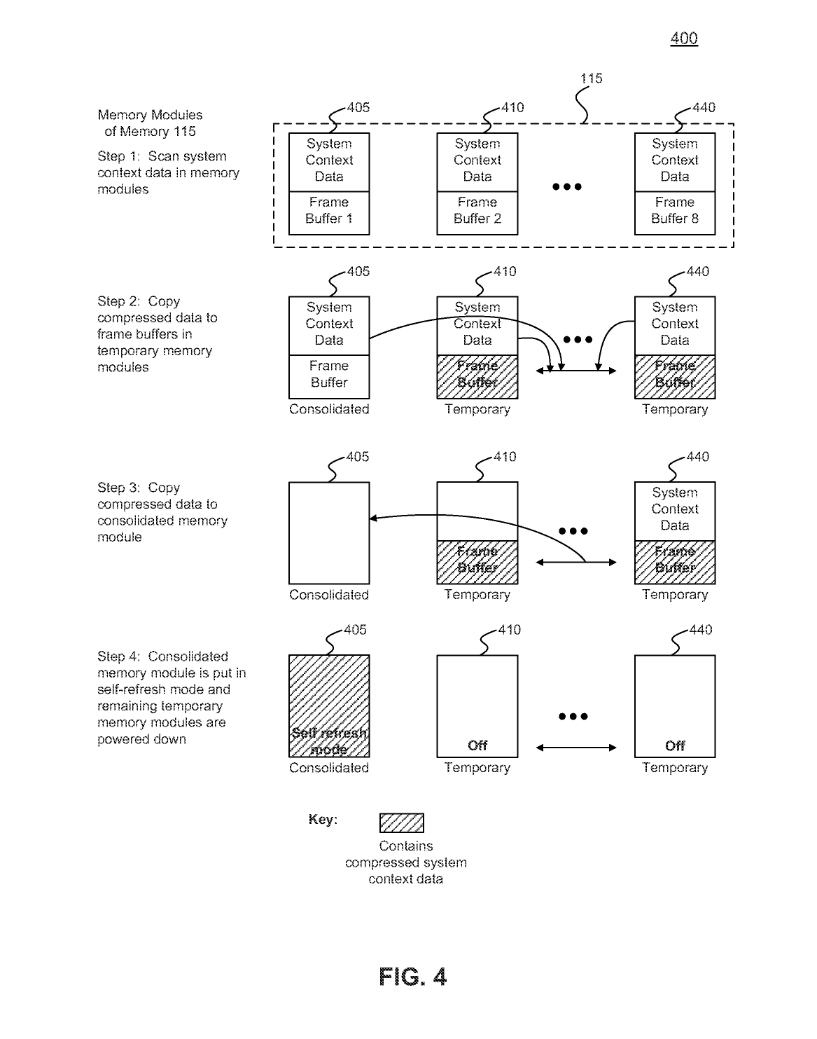

FIG. 4 is a diagram depicting a method 400 for entering reduced-power sleep state S3, according to an embodiment. In one example, system 100 and memory module 200 may be used to perform method 400. It is to be appreciated that operations in method 400 may be performed in a different order than shown, and method 400 may not include all operations shown. For ease of discussion, and without limitation, method 400 will be described in terms of elements shown in FIG. 1 and FIG. 2.

For illustrative purposes, and not limitation, an example of an embodiment for entering reduced-power sleep state S3 is described with eight memory modules 405-440 of memory 115. Memory modules 405-440 can be dual in-line memory modules (DIMMs), for example. CPU 110 sends an indication to ACPI module 126 that CPU 110 is entering reduced-power sleep state S3.

In step 1, CPU 110 scans system context data 205 in memory 115 and determines based on the total amount of system context data 205 in memory 115, that memory modules 410-440 will be temporary memory modules and memory module 405 will be a consolidated memory module, i.e., CPU 110 determines that one DIMM, memory module 405, is sufficient to store the total system context data 205 from the eight DIMMs compressed, and the remaining seven DIMMs, memory modules 410-440, can be powered down.

In step 2, CPU 110 compresses system context data 205 in memory modules 405-440 and copies the compressed data to frame buffer memory 210 of temporary memory modules 410-440. In an embodiment, CPU 110 compresses system context data 205 to a scratch pad memory 215 (not shown) in a frame buffer memory 210 (not shown) in memory modules 405-440 and copies the compressed data to scratch pad memory 215 (not shown) of the frame buffer memory 210 of temporary memory modules 410-440.

In step 3, consolidated memory module 405 does not contain compressed data and is available for storage. CPU 110 copies the compressed data from the frame buffer memory 210 of temporary memory modules 410-440 to consolidated memory module 405. In an embodiment, CPU 110 copies the compressed data from the scratch pad memory 215 (not shown) of the frame buffer memory 210 of temporary memory modules 410-440 to the consolidated memory module 405.

In step 4, consolidated memory module 405 now contains all of the compressed data of memory 115. CPU 110 causes consolidated memory module 405 to be placed in self-refresh mode; in self-refresh mode, consolidated memory module 405 is in a lower power mode and cannot be accessed (e.g., for read or write). CPU 110 also causes the remaining seven DIMMs, temporary memory modules 410-440 to be powered down.

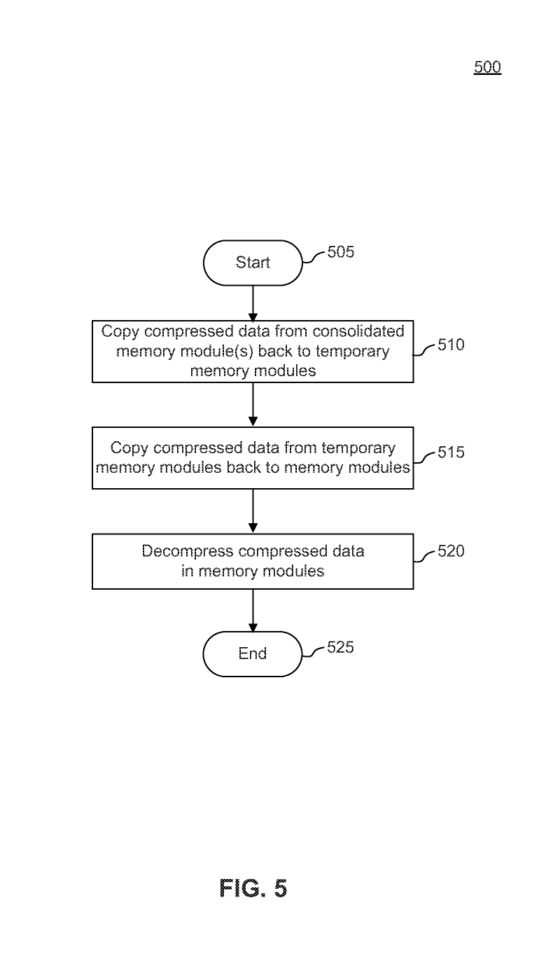

FIG. 5 is a flowchart depicting method 500 for exiting reduced-power sleep state S3, according to an embodiment. In one example, system 100 and memory module 200 may be used to perform method 500. It is to be appreciated that operations in method 500 may be performed in a different order than shown, and method 500 may not include all operations shown. For ease of discussion, and without limitation, method 500 will be described in terms of elements shown in FIG. 1 and FIG. 2.

ACPI module 125 may receive indications from a peripheral device, such as a mouse, or other indications, that cause ACPI module 125 to wake up system 100. ACPI module 125 powers up the temporary memory modules of memory 115 that were previously powered down, as well as CPU 110, graphics engine 105, and disk drive 120. In addition, the one or more consolidated memory modules are removed from self-refresh mode and returned to a regular power mode, i.e., the one or more consolidated memory modules are put back into an active mode and can be readily accessed (e.g., for read or write). Once memory 115 is powered up, method 500 begins.

The method begins at step 505 and proceeds to step 510.

In step 510, CPU 110 copies the compressed data from the respective consolidated memory modules back to the respective temporary memory modules from which the compressed data originated.

In step 515, CPU 110 copies the compressed data from the respective temporary memory modules back to the memory modules from which the compressed data originated.

In step 520, CPU 110 decompresses the compressed data in the memory modules of memory 115 and system context is restored.

In step 525 method 500 ends.

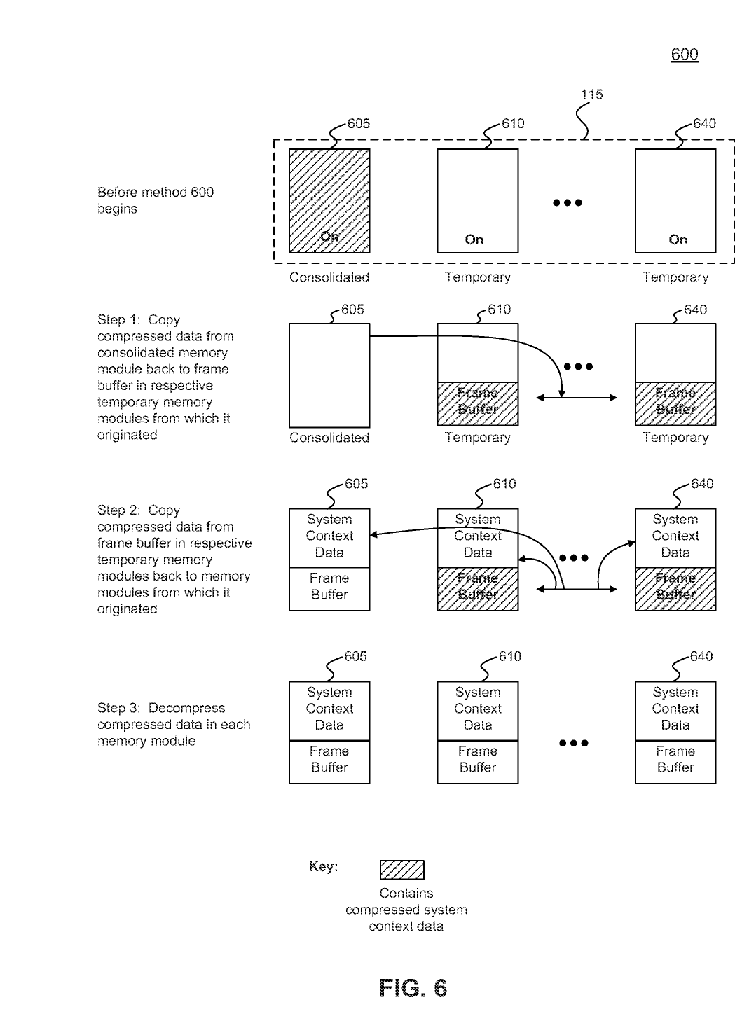

FIG. 6 is a diagram depicting a method 600 for exiting reduced-power sleep state S3, according to an embodiment. In one example, system 100 and memory module 200 may be used to perform method 600. It is to be appreciated that operations in method 600 may be performed in a different order than shown, and method 600 may not include all operations shown. For ease of discussion, and without limitation, method 600 will be described in terms of elements shown in FIG. 1 and FIG. 2.

For illustrative purposes, and not limitation, an example of an embodiment for exiting reduced-power sleep state S3 is described with eight memory modules 605-640 of memory 115 that are substantially the same as memory modules 405-440 of FIG. 4.

In an example operation, before method 600 begins, ACPI module 125 powers up temporary memory modules 610-640, as well as CPU 110, graphics engine 105, and disk drive 120. Memory module 605 containing the compressed, consolidated system context is moved from self-refresh mode to a regular power mode.

In step 1, CPU 110 copies the compressed data from consolidated memory module 605 back to the frame buffer memory 210 of temporary memory modules 610-640 from which the compressed data originated. In an embodiment, CPU 110 copies the compressed data from consolidated memory module 605 back to the scratch pad memory 215 (not shown) of the frame buffer memory 210 of temporary memory modules 610-640 from which the compressed data originated.

In step 2, CPU 110 copies the compressed system data from the frame buffer memory 210 of temporary memory modules 610-640 back to memory modules 605-640 from which the compressed data originated. In an embodiment, CPU 110 copies the compressed system data from the scratch pad memory 215 (not shown) of frame buffer memory 210 of temporary memory modules 610-640 back to the scratch pad memory 215 (not shown) of frame buffer memory 210 (not shown) of memory modules 605-640 from which the compressed data originated.

In step 3, CPU 110 decompresses the compressed data in memory modules 605-640, and system context is restored.

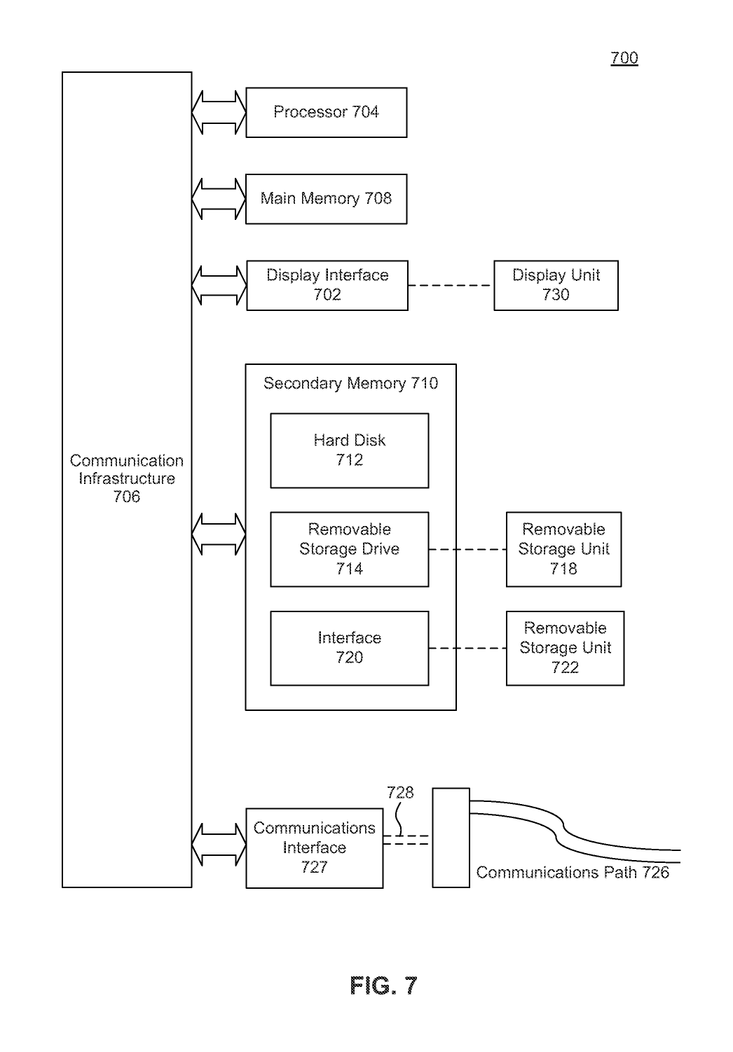

Various aspects of the disclosure can be implemented by software, firmware, hardware, or a combination thereof. FIG. 7 illustrates an example computer system 700 in which some embodiments, or portions thereof, can be implemented as computer-readable code. For example, the methods 300-600, of FIGS. 3 through 6 can be implemented in system 700. Various embodiments are described in terms of the example computer system 700. After reading this description, it will become apparent to a person skilled in the relevant art how to implement the embodiments using other computer systems and/or computer architectures.

Computer system 700 includes one or more processors, such as processor 704. Processor 704 can be a special purpose or a general purpose processor. Examples of processor 704 are CPU 110 and graphics engine 105 of FIG. 1, or a GPU, GPGPU, APU as described earlier. Processor 704 is connected to a communication infrastructure 706 (for example, a bus or network) such as bus 130 of FIG. 1.

Computer system 700 also includes a main memory 708, such as random access memory (RAM) such as memory 115 of FIG. 1, and may also include a secondary memory 710. Secondary memory 710 may include, for example, a hard disk drive 120, a removable storage drive 714, and/or a memory stick. Removable storage drive 714 may comprise a floppy disk drive, a magnetic tape drive, an optical disk drive, a flash memory, or the like. The removable storage drive 714 reads from and/or writes to a removable storage unit 718 in a well-known manner. Removable storage unit 718 may comprise a floppy disk, magnetic tape, optical disk, etc. that is read by and written to by removable storage drive 714. As will be appreciated by persons skilled in the relevant art(s), removable storage unit 718 includes a computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 that allow software and data to be transferred from the removable storage unit 722 to computer system 700.

Computer system 700 may also include a communications interface 724. Communications interface 724 allows software and data to be transferred between computer system 700 and external devices. Communications interface 724 may include a modem, a network interface (such as an Ethernet card), a communications port, a PCMCIA slot and card, or the like. Software and data transferred via communications interface 724 are in the form of signals that may be electronic, electromagnetic, optical, or other signals capable of being received by communications interface 724. These signals are provided to communications interface 724 via a communications path 726. Communications path 726 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 718, removable storage unit 722, and a hard disk installed in hard disk drive 412. Signals carried over communications path 726 can also embody the logic described herein. Computer program medium and computer usable medium can also refer to memories, such as main memory 708 and secondary memory 710, which can be memory semiconductors (e.g. DRAMs, etc.). These computer program products are means for providing software to computer system 700.

Computer programs (also called computer control logic) are stored in main memory 708 and/or secondary memory 710. Computer programs may also be received via communications interface 724. Such computer programs, when executed, enable computer system 700 to implement the embodiments as discussed herein. In particular, the computer programs, when executed, enable processor 704 to implement the disclosed processes, such as the steps in the methods 300-600 of FIGS. 3-6 as discussed above. Accordingly, such computer programs represent controllers of the computer system 700. Where the embodiments are implemented using software, the software may be stored in a computer program product and loaded into computer system 700 using removable storage drive 714, interface 720, hard drive 712 or communications interface 727. This can be accomplished, for example, through the use of general-programming languages (such as C or C++). The computer program code can be disposed in any known computer-readable medium including semiconductor, magnetic disk, or optical disk (such as, CD-ROM, DVD-ROM). As such, the code can be transmitted over communication networks including the Internet and internets. It is understood that the functions accomplished and/or structure provided by the systems and techniques described above can be represented in a core (such as a processing-unit core) that is embodied in program code and may be transformed to hardware as part of the production of integrated circuits. This can be accomplished, for example, through the use of hardware-description languages (HDL) including Verilog HDL, VHDL, Altera HDL (AHDL) and so on, or other available programming and/or schematic-capture tools (such as, circuit-capture tools).

Embodiments are also directed to computer program products comprising software stored on any computer useable medium. Such software, when executed in one or more data processing device, causes a data processing device(s) to operate as described herein. Embodiments employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the disclosure and the appended claims in any way.

The disclosure has been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A method comprising:
responsive to a signal to enter a reduced-power state, storing, by a processing unit, compressed data in a memory device that includes consolidated and temporary memory modules;
a first copying, by the processing unit, the compressed data to respective ones of the temporary memory modules;
a second copying, by the processing unit, the compressed data from respective ones of the temporary memory modules to respective ones of the consolidated memory modules; and
causing, by the processing unit, respective ones of the consolidated memory modules to be placed into self-refresh mode.

2. The method of claim 1, further comprising:
causing, by the processing unit, respective ones of the temporary memory modules to be powered down.

3. The method of claim 1, wherein the first copying further comprises:
copying, by the processing unit, the compressed data to a scratch pad memory within a frame buffer memory, within respective ones of the temporary memory modules.

4. The method of claim 1, wherein responsive to a signal to exit the reduced-power state, the method further comprises:
causing, by the processing unit, the respective ones of the consolidated memory modules to return to a regular power mode;
a third copying, by the processing unit, the compressed data from the respective ones of the consolidated memory modules to the respective ones of the temporary memory modules;
a fourth copying, by the processing unit, the compressed data from the respective ones of the temporary memory modules back to memory modules from which the compressed data originated; and
decompressing, by the processing unit, the compressed data in the memory modules.

5. The method of claim 1, wherein the compressed data in the memory device includes at least one of: system configuration information, application data, operating system information, user data, and displayed images.

6. The method of claim 1, further comprising:
scanning, by the processing unit, the memory device;
determining, by the processing unit, based on data in the memory device, the minimum number of respective ones of the consolidated memory modules needed to store the compressed data; and
identifying, by the processing unit, respective ones of the temporary memory modules and respective ones of the consolidated memory modules of the memory device.

7. The method of claim 1, wherein a memory module is a Dynamic Random-access Memory (DRAM) module.

8. A computer-readable storage device having stored thereon instructions, execution of which, by a processing unit, cause the processing unit to perform operations comprising:
responsive to a signal to enter a reduced-power state, storing compressed data in a memory device that includes consolidated and temporary memory modules;
a first copying the compressed data to respective ones of the temporary memory modules;
a second copying the compressed data from respective ones of the temporary memory modules to respective ones of the consolidated memory modules; and
causing, respective ones of the consolidated memory modules to be placed into self-refresh mode.

9. The computer-readable storage device of claim 8, wherein the operations further comprise:
causing respective ones of the temporary memory modules to be powered down.

10. The computer-readable storage device of claim 8, wherein the operations for the first copying further comprise:
copying the compressed data to a scratch pad memory within a frame buffer memory, within respective ones of the temporary memory modules.

11. The computer-readable storage device of claim 8, wherein responsive to a signal to exit the reduced-power state, the operations further comprise:
causing the respective ones of the consolidated memory modules to return to a regular power mode;
a third copying the compressed data from the respective ones of the consolidated memory modules to the respective ones of the temporary memory modules;
a fourth copying the compressed data from the respective ones of the temporary memory modules back to memory modules from which the compressed data originated; and
decompressing the compressed data in the memory modules.

12. The computer-readable storage device of claim 8, wherein the compressed data in the memory device includes at least one of: system configuration information, application data, operating system information, user data, and displayed images.

13. The computer-readable storage device of claim 8, wherein the operations further comprise:
scanning the memory device;
determining based on data in the memory device, the minimum number of respective ones of the consolidated memory modules needed to store the compressed data; and
identifying respective ones of the temporary memory modules and respective ones of the consolidated memory modules of the memory device.

14. The computer-readable storage device of claim 8, wherein a memory module is a Dynamic Random-access Memory (DRAM) module.

15. A processing unit comprising one or more compute units configured to:
responsive to a signal to enter a reduced-power state, store compressed data in a memory device that includes consolidated and temporary memory modules;
a first copy the compressed data to respective ones of the temporary memory modules;
a second copy the compressed data from respective ones of the temporary memory modules to respective ones of the consolidated memory modules; and
cause respective ones of the consolidated memory modules to be placed into self-refresh mode.

16. The processing unit of claim 15, further configured to:
cause respective ones of the temporary memory modules to be powered down.

17. The processing unit of claim 15, wherein the first copy is further configured to:
copy the compressed data to a scratch pad memory within a frame buffer memory, within respective ones of the temporary memory modules.

18. The processing unit of claim 15, wherein responsive to a signal to exit the reduced-power state, the processing unit is further configured to:
cause the respective ones of the consolidated memory modules to return to a regular power mode;
a third copy the compressed data from the respective ones of the consolidated memory modules to the respective ones of the temporary memory modules;
a fourth copy the compressed data from the respective ones of the temporary memory modules back to memory modules from which the compressed data originated; and
decompress the compressed data in the memory modules.

19. The processing unit of claim 15, wherein the compressed data in the memory device includes at least one of: system configuration information, application data, operating system information, user data, and displayed images.

20. The processing unit of claim 15, further configured to:
scan the memory device;
determine based on data in the memory device, the minimum number of respective ones of the consolidated memory modules needed to store the compressed data; and
identify respective ones of the temporary memory modules and respective ones of the consolidated memory modules of the memory device.
